(19) United States
(12) Patent Application Publication
(10) Pub. No.: US 2005/0243750 A1
(43) Pub. Date: Nov. 3, 2005

(54) Digital radio broadcasting systems and receivers

(76) Inventors: Nicholas Jurascheck, Herts (GB); Colin Crawford, Hereford (GB)

Correspondence Address: FLYNN THIEL BOUTELL & TANIS, P.C., 2026 RAMBLING ROAD, KALAMAZOO, MI, 49008-1631, US

(21) Appl. No.: 10/995,871

(22) Filed: Nov. 23, 2004

(30) Foreign Application Priority Data
Apr. 15, 2004 (GB) 0408459.6

(51) Int. Cl. H04H 1/00

(52) U.S. Cl. 370/312

(57) ABSTRACT

The broadcast radio system has at least one transmitter broadcasting radio signals to a plurality of receivers. At the transmitter there is provided a means for including additional data specifically addressed to at least one of the receivers. Each receiver includes means to detect whether any received additional data is addressed specifically to it and enable it to decode and operate on the additional data.

### FIELD OF THE INVENTION

This invention relates to digital radio broadcasting systems and receivers and particularly to systems in which software and firmware in receivers can be updated.

### BACKGROUND TO THE INVENTION (PRIOR ART)

Digital Audio Broadcast (DAB) is an internationally recognised standard, based on the system developed by the Eureka 147 project. The DAB standard and other digital radio standards allow the transmission of general-purpose digital data as well as audio.

Various existing digital radio receivers allow users to upgrade the product's firmware by connecting the unit to a PC with a USB cable, and running a software upgrade application on the PC. This application, which is typically downloaded from the product manufacturer's website, replaces the firmware in the unit with a different firmware version. Since the digital radio product has a highly programmable processor, this ‘firmware upgrade’ may provide bug fixes, improved or entirely new functionality, a different ‘look and feel’ user interface etc. Such firmware upgrades and other data content for digital radios can also be delivered via storage media such as SD card or CD-ROM.

Existing digital radio systems do not allow narrow-casting of data to specific users or groups of users. This means that services such as sending messages to individual receivers, providing off-air software upgrades to a specific subset of receivers or providing secure delivery of content to designated individual users is not possible.

### SUMMARY OF THE INVENTION

Preferred embodiments of the present invention solve the problem of using a broadcast medium such as digital radio to narrow-cast data, by providing a means for uniquely identifying digital radio receivers and a mechanism for tagging data so that it is recognised only by those receivers within the target group. As a result, a number of new personalised content delivery services are enabled which would not otherwise be possible, including the provision of firmware upgrades to specific receivers or groups of receivers.

A preferred embodiment of the invention gives each digital radio receiver a unique identification based on a hardware serial number, and specifies tag information (meta-data) to be attached to the broadcast data for delivery to the uniquely identified receivers. Together these items provide a means for a digital radio broadcaster to deliver content to a specific receiver or set of receivers (“narrow-cast”).

Preferably there is also specified means for user interaction with the system, via a website form or via mobile phone SMS messaging system, allowing the user to generate data which can then be broadcast to individual receivers as described above. For example, users may input messages to be sent to a specific radio receiver, or set preferences for their receiver, or customise their receiver's firmware using the unique serial number.

### DETAILED DESCRIPTION OF PREFERRED EMBODIMENT

A preferred embodiment of the invention may now be described in detail by way of example with reference to the accompanying figures in which:

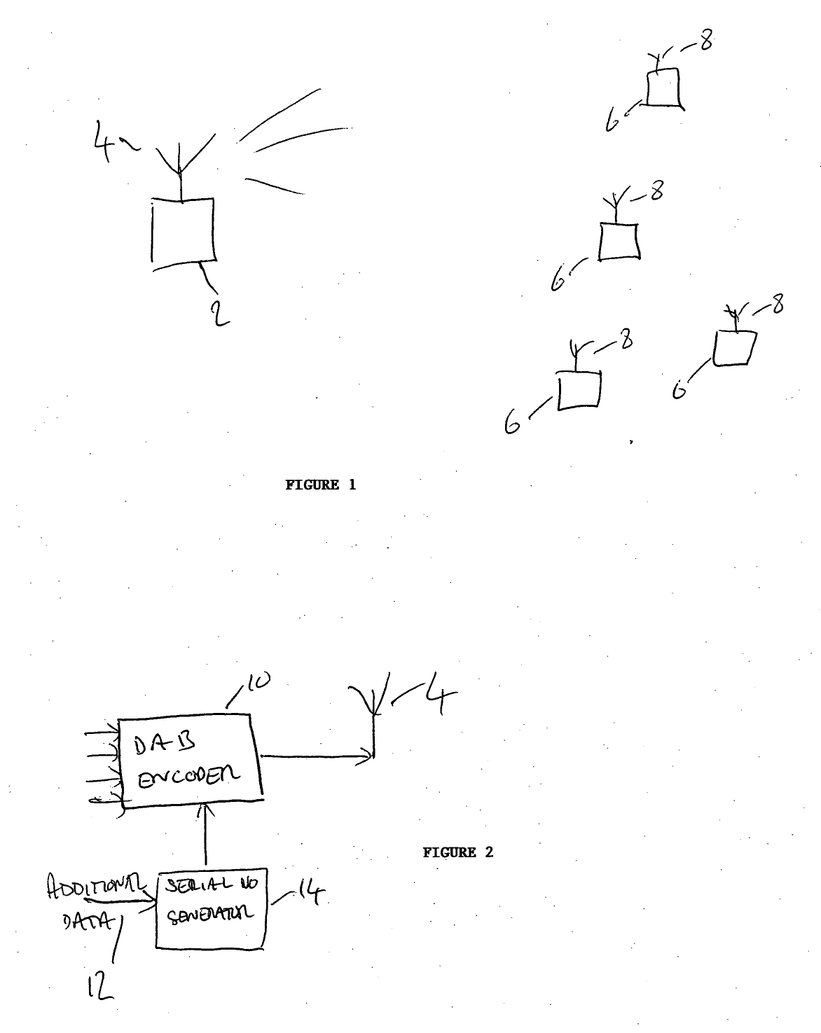

FIG. 1 shows schematically the transmitter and a plurality of receivers in a digital audio broadcast system;

FIG. 2 shows a block diagram of a transmitter embodying the invention; and

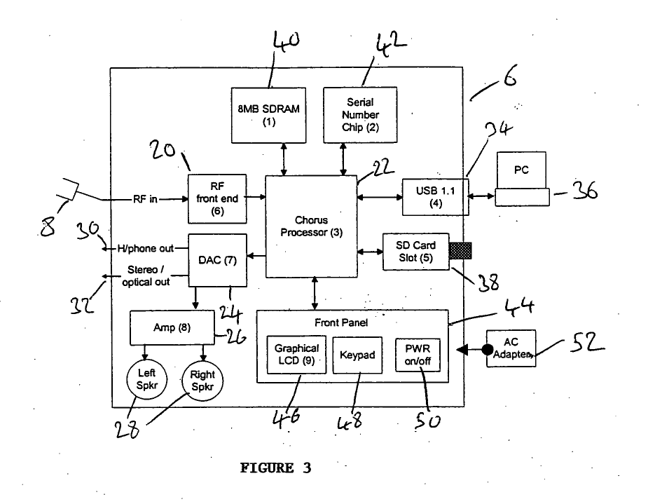

FIG. 3 shows a block diagram of a receiver embodying the invention.

In FIG. 1 a transmitter 2 transmits via its antenna 4 a digital audio broadcast signal. This is received by a plurality of receivers 6, each via its own antenna 8.

A digital audio broadcast signal comprises a series of broadcast frames, each comprising a plurality of symbols. Included in the frame is a frame header which includes various housekeeping data for the transmission such as which symbol comprises which channel. This header has spare capacity into which additional data can be included. Alternatively, one or more of the symbols could be used for additional data.

In order to narrow cast data to specific receivers or groups of receivers each receiver is given a unique serial number within a predetermined range. The data destined for a specific receiver and included in the transmission can then be tagged with data identifying the specific serial number or range of serial numbers to be targeted and the receivers can be configured to identify this tagging and to download the additional data included in the DAB transmission.

In FIG. 2 a diagram of the transmitter is shown. This comprises a DAB encoder 10 receiving various radio channel inputs. These are encoded by the DAB encoder into a plurality of symbols for inclusion in a DAB frame. Additional data which is to be narrow casted to the receivers is shown at 12. This goes first to a serial number generator which uses data included in the additional data to identify the serial numbers of the receiver or receivers which are to use the additional data. The additional data and the serial number data are then provided to the DAB encoder 10 which includes these in the DAB frame which is transmitted via the transmitter 4.

FIG. 3 shows a schematic diagram of a receiver 6. A signal is received by the antenna 8. The RF signal is decoded by the RF front end circuitry 20 before being provided to a Chorus (TM) DAB processor 22. This decodes the digital audio broadcast signal and provides it to a digital to analog converter 24 from where it can be provided by an amplifier 26 to left and right speakers 28 or to a headphone output socket 30 or to a stereo optical output socket 32.

The processor is also connected to a USB terminal 34 which enables it to be connected to a PC 36 for programming and upgrades. It is also connected to an SD card slot 38 which it can use to upload the new programming data or to record received radio signals onto.

The processor has access to an 8 megabyte SDRAM 40 which it uses for temporary storage and to a serial number chip 42 which stores a unique serial number identifying the receiver. This serial number falls within a predetermined range.

The receiver is controlled by a front panel 44 which includes a graphical LCD display 46, a key pad 48 and a power on/off switch 50. An AC adapter 52 provides power for the receiver.

The DAB processor 22 uses firmware (semi-permanently stored software) which is stored in an internal memory. This is loaded for use when a receiver is powered up. This firmware includes a software upgrade routine which allows it to replace parts of its own code with new firmware.

The unique serial number stored in serial number chip 42 is, for example, a 48 bit read only serial number. This is stored on the chip 42 when the receiver is manufactured. Also stored in the receiver firmware at manufacture is further information such as product family, product type and a list of product specific capabilities such as LCD resolution, SDRAM size, SD card etc. These may all be used in identifying and targeting the need for upgrades.

When a narrowcast is to be sent to a specific receiver or to a range of serial numbers of receivers the additional data 12 will include tag data which includes a serial number range comprising a serial number start field and a serial number end field. This may be, for example, a 48 bit number. If serial number start and serial number end are different then the data will target all receivers with serial numbers falling between the serial numbers start field and the serial number end field values. If serial number start and serial number end are the same then the data will target one specific receiver having that serial number.

As an alternative, if both serial number start and serial number end fields are set to zero then the additional data will apply to all receivers. When the receiver 6 decodes in the DAB processor 22 the additional data, it compares the serial number start and serial number end fields with the serial number stored in chip 42. It determines whether or not the serial number is the same as or falls between the values in the two fields. If it does, then the processor goes on to download the additional data included in the DAB frame.

In addition, the data can include specific fields for product family version and other attributes representing minimum hardware/system requirements. These attributes can be used instead of (or as well as) the serial number range to identify target receivers. For example, a firmware upgrade could be tagged as follows:
Serial no. start 0
Serial no. end 0
Product family XYZ
Product version 2.0
SD RAM 16 MB
LCD colour
SD card yes
Upgrade status recommended

Such a set of data would be intended to upgrade a group of receivers identified by the special attributes, regardless of serial number. When the additional data is decoded by the DAB processor 22 it will identify the fact that the upgrade (or other data) is intended for it (along with other receivers) and can then make a decision as to whether or not to process the data and offer the upgrade to the user, based on the various attributes received with the data. For example, if the receiver belongs to product family XYZ with 8 MB of SDRAM, a monochrome LCD display and SD card connector then the upgrade would not be processed. If it belongs to family XYZ, it is version 2.0 with 16 MB D-RAM colour LCD and an SD card connector then the upgrade would be offered to the user as an a recommended upgrade. Other types of digital radio receivers would ignore the upgrade simply by inspecting the received data.

The broadcasting of the data will be at the manufacturer's request by the broadcasters of digital radio in a specified area. Manufacturers will have to liase with broadcasters to ensure that these upgrades are sent. Clearly, not all of the receivers requiring an upgrade will be switched on all the time. However, many receivers are provided with a standby mode which they may automatically come out of when relevant data is received. Alternatively, the upgrades can be sent over a number of days at different times. Another alternative would be to notify users via e.g. email that an upgrade was to become available via a broadcast so that they can ensure that their receivers are switched on at the correct time. Any user who does not receive the upgrade via a broadcast can obtain it via a PC download.

Another use for such a system is peer to peer messaging. When a receiver embodying the invention is purchased, the purchaser can be invited to register the receiver and to give themselves a specific user name. This user name can then be used by others via a website to request that messages be sent to that user. The website will wait until it has a batch of messages and will convert them into serial number tagged digital radio format data for inclusion in a transmission as the additional data as described above. In this case, the messages will go to specific receivers and serial number start and serial number end fields will be the same on each message.

As an alternative, the messages can be originated from SMS text messages which include the destination address (i.e. the target receivers serial number or registered user name as above) and are sent to a central location. A similar batch process is then used to transmit the messages to receivers.

The use of a website also enables users to select upgrades for receivers. A plurality of software components can be edited or selected by the user on the website. The website will then generate a customised receiver upgrade for that user's serial number and will advise the user of when this is to be broadcast. The user defined upgrades can be as simple as selecting from a plurality of icons for the display, including user defined icons but may be more sophisticated.

The use of the serial numbers on receivers also enables the content specific transmissions to be sent to receivers. Therefore, a user might register for a particular channel and the serial number identification process could be used by the receiver to determine whether or not he is in fact entitled to receive that channel. Similarly data such as music tracks could be received by specific users who have subscribed to a music download service by registering their receiver's serial number.

If security is required then the additional data can be encrypted prior to transmission and decrypted at the receiver. Preferably the unique serial number is used as a key to encrypt and decrypt the data.

1. A broadcast radio system comprising at least one transmitter for broadcasting radio signals to a plurality of receivers
the transmitter including means for including additional data specifically addressed to at least one of the receivers; and,
each receiver including means to detect whether any received additional data is addressed specifically to it, and means for decoding and operating on the additional data.

2. A broadcast radio system according to claim 1 in which each receiver has a unique identification number and the additional data is specifically addressed to a unique identification number.

3. A broadcast radio system according to claim 2 in which the additional data is addressed to a range of unique identification numbers.

4. A broadcast radio system according to claims 1, 2 or 3 in which the additional data includes further attributes of a receiver and the receiver uses these to determine whether or not to operate on the received additional data.

5. A broadcast radio system according to claims 1 to 4 including an external interface into which a user may select data to be sent to a receiver as additional data.

6. A broadcast radio system according to any preceeding claim in which the additional data is software upgrade data.

7. A receiver for use in a broadcast radio system comprising means to receive broadcast radio signals, means to detect additional data received within a transmission, means to detect whether or not any received additional data is addressed specifically to that receiver, and means for decoding and operating on the additional data.

8. A radio receiver according to claim 7 including a unique identification number and means for comparing the unique identification number with an identification number included in the additional data.

9. A radio receiver according to claims 7 or 8 including means for determining whether or not the additional data includes other attribute data and means for comparing attributes of the receiver with these other attributes and means for determining whether or not to operate on the received additional data in dependence on the result of the comparison.

10. A method of broadcasting radio signals to a plurality of receivers comprising the steps of including additional data addressed to at least one of the receivers in the transmission.
